(19) United States
(12) Patent Application Publication
(10) Pub. No.: US 2005/0247739 A1
(43) Pub. Date: Nov. 10, 2005

(54) CARBONATED BEVERAGE DISPENSER

(75) Inventors: Robert Grant, Alpharetta, GA (US); Scott C. Biondich, Alpharetta, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA CO., Atlanta, GA (US)

(21) Appl. No.: 10/908,247

(22) Filed: May 4, 2005

Related U.S. Application Data
(60) Provisional application No. 60/521,486, filed on May 5, 2004.

(51) Int. Cl. B67B 5/00

(52) U.S. Cl. 222/386

(57) ABSTRACT

A bottle. The bottle may include an expanded rear end, an offset spout, and a substantially flat side positioned between the expanded rear end and the offset spout.

### RELATED APPLICATIONS

The present application claims priority to U.S. Provisional Patent Application No. 60/521,486, filed on May 5, 2004, incorporated herein by reference.

### TECHNICAL FIELD

The present invention relates generally to a beverage dispenser and more particularly relates to a carbonated beverage dispenser that may be stored in a conventional refrigerator.

### BACKGROUND OF THE INVENTION

Current multi-serve carbonated soft drink beverage bottles, e.g., a two (2) liter PET (“Polyethylene Terephthalate”) bottle, generally release headspace carbon dioxide (CO₂) to the atmosphere each time the closure is opened. After the closure is reapplied, some of the entrapped carbon dioxide within the product migrates into the headspace until equilibrium exists between the product and the empty space within the bottle. This cycle continues each time the bottle is opened. As the product continues to be consumed, a larger headspace must come to equilibrium. As a result, a typical two (2) liter PET bottle of a carbonated soft drink may lose carbonation, i.e., may go flat, when the bottle is approximately half full or after being opened about five (5) or six (6) times.

Other concerns with current multi-serve beverage bottles may include difficulty in carrying, pouring, and storing the bottles. For example, consumers may have great confidence in the original seal between the closure and the bottle. As such, consumers may be willing to lay the bottle on its side in the refrigerator. Once opened and resealed, however, this confidence may be lost and the bottle typically may be stored upright. This upright storage position, however, may limit the consumer's storage options. Further, most multi-serve beverage bottles use a straight wall design. Consumers may find it difficult to differentiate among brands using these straight wall design bottles. Rather, consumers seem to prefer a contoured shape and/or a bottle with a handle.

There is a desire, therefore, for a multi-serve carbonated soft drink package and system that maintains product freshness (carbon dioxide content within the beverage), eliminates handling issues by dispensing directly from the refrigerator, and allows consumers the opportunity to control the serving size. The purchaser or the consumer preferably should be aware of the added functional benefits that the new package design may provide when selecting the product.

### SUMMARY OF THE INVENTION

The present application thus may describe a bottle. The bottle may include an expanded rear end, an offset spout, and a substantially flat side positioned between the expanded rear end and the offset spout.

The bottle may be made out of PET or aluminum. The expanded end may generally have the shape of a semi-sphere. The flat side may include a number of support ribs therein and may include an angle towards the offset spout. The bottle further may include a curved side opposite the flat side and an internal web. The internal web may be in a substantially perpendicular position with respect to the flat side.

The bottle further may include a closure positioned on the offset spout. The closure may include an umbrella valve or a vent-less closure. The bottle may include an evacuation tube positioned therein. A dust cap, a handle, and/or a support base also may be used herein.

The present application further may describe a beverage dispenser for a carbonated beverage. The beverage dispenser may include a bottle with a first end and a second end. The first end may be rounded and the second end may include an offset spout. The bottle further may include a flat first side and a curved second side. A closure may be mounted onto the spout. The closure may remain in contact with the carbonated beverage therein when dispensing.

The closure may be a vented closure or a vent-less closure. The bottle may include an internal web. The internal web may be in a substantially perpendicular position with respect to the flat side.

A container may be positioned about the bottle. The container may include a rectangular shape. The container may include foam inserts positioned about the bottle and an aperture therein for the addition of ice or other types of means for cooling.

The present application further may describe a dispenser for a fluid. The dispenser may include a fluid container. The fluid container may include a flat side and an internal web. The fluid container may include an offset spout and a curved side opposite the flat side. The closure may be a vented closure or a vent-less closure. The beverage dispenser further may include a rectangular box surrounding the fluid container.

These and other features of the present invention will become apparent upon review of the following detailed description when taken in conjunction with the drawings and the appended claims.

### BRIEF DESCRIPTION OF THE DRAWINGS

FIG. 1 is a perspective view of an embodiment of a carbonated beverage dispenser to be positioned within a conventional refrigerator.

FIG. 2 is a side cut-away view of a bottle, a closure, and a container of a carbonated beverage dispenser.

FIG. 3 is perspective view of a bottle for use with a carbonated beverage dispenser.

FIG. 4 is a side plan view of the bottle of FIG. 3.

FIG. 5 is a bottom plan view of the bottle of FIG. 3.

FIG. 6 is a flat side plan view of the bottle of FIG. 3.

FIG. 7 is a cross-sectional view taken along line 7-7 of FIG. 6.

FIG. 8 is a perspective view of a further embodiment of a bottle for use with the carbonated beverage dispenser.

FIG. 9 is a top plan view of the bottle of FIG. 8.

FIG. 10 is a bottom plan view of the bottle of FIG. 8.

FIG. 11 is a side view of a bottle with an evacuation tube therein.

FIG. 12 is a perspective view of a bottle with a base.

FIG. 13 is a side view of the bottle with the base of FIG. 12.

FIG. 14 is a side view of a bottle with a dust cap.

FIG. 15 is a further side view of the bottle with the dust cap of FIG. 14.

FIG. 16 is a perspective view of a bottle with a dust cap.

FIG. 17 is a side view of the bottle with the dust cap of FIG. 16.

FIG. 18 is a side view of a bottle with a handle.

FIG. 19 is a further side view of the bottle with the handle of FIG. 18.

FIG. 20 is a further side view of the bottle with the handle of FIG. 18.

FIG. 21 is a perspective view of a bottle with a handle.

FIG. 22 is a side view of the bottle with the handle of FIG. 21.

FIG. 23 is a side cross-sectional view of a vented closure.

FIG. 24 is a side cross-sectional view of a vent-less closure.

FIG. 25 is a perspective view of a bottle with two curved sides.

FIG. 26 is a perspective view of a container with foam inserts.

FIG. 27 is a perspective view of a container with an ice aperture.

### DETAILED DESCRIPTION

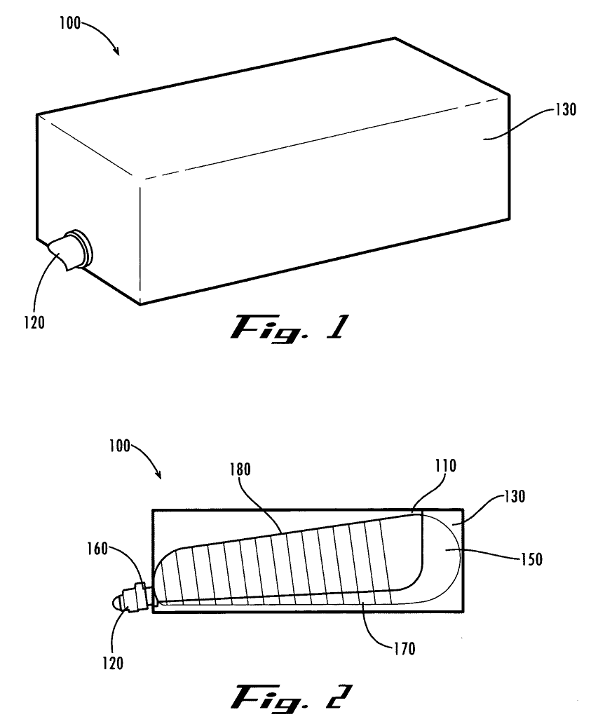

Referring now to the drawings, in which like numerals refer to like parts throughout the several views, FIGS. 1 and 2 show an example of a carbonated beverage dispenser 100 as is described herein. The carbonated beverage dispenser 100 may be used in a conventional refrigerator or cooler and also may be used independently. As is shown, the carbonated beverage dispenser 100 may include a bottle 110. The bottle 110 may have a closure 120 that allows product to be dispensed therefrom while maintaining carbonation within the bottle 110. The bottle 110 may be positioned within a container 130. The bottle 110 also may be used on its own without the container 130.

The bottle 110 preferably may be made from PET or similar materials. Other types of plastics or metals such as aluminum also may be used. The bottle 110 may range in size from about one (1) liter to about five (5) liters although any size may be used. The bottle 110 preferably can be made with existing bottling equipment and filled with existing filling equipment. As such, the overall length of the bottle 110 generally may be less than about 400 millimeters with the height of the bottle 110 under the neck portion being no more than about 340 millimeters. The diameter of the bottle 110 should be able to meet the 130 millimeter allowance for most existing blow molds. Other sizes and shapes may be used herein.

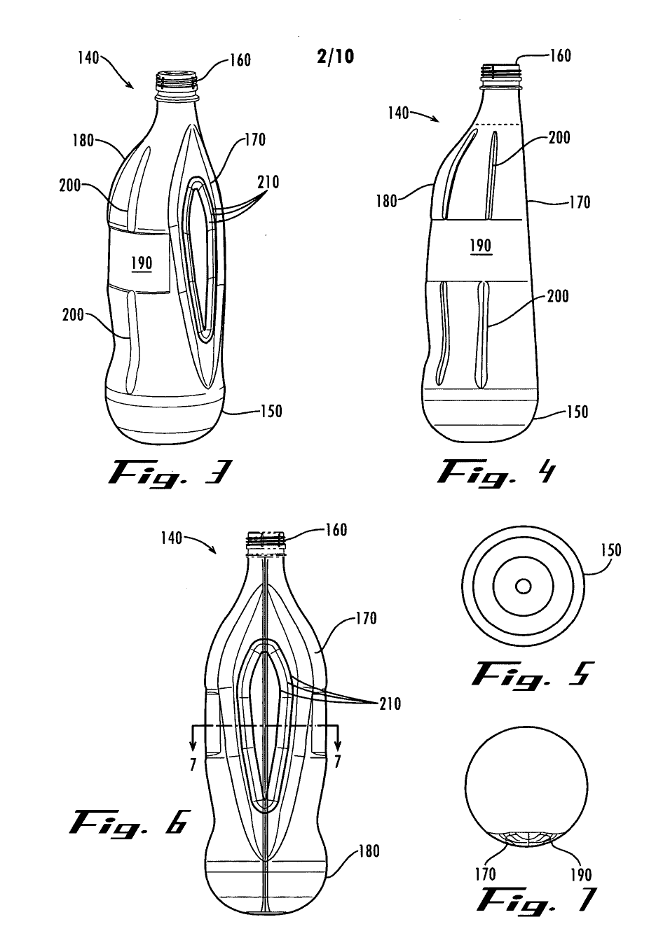

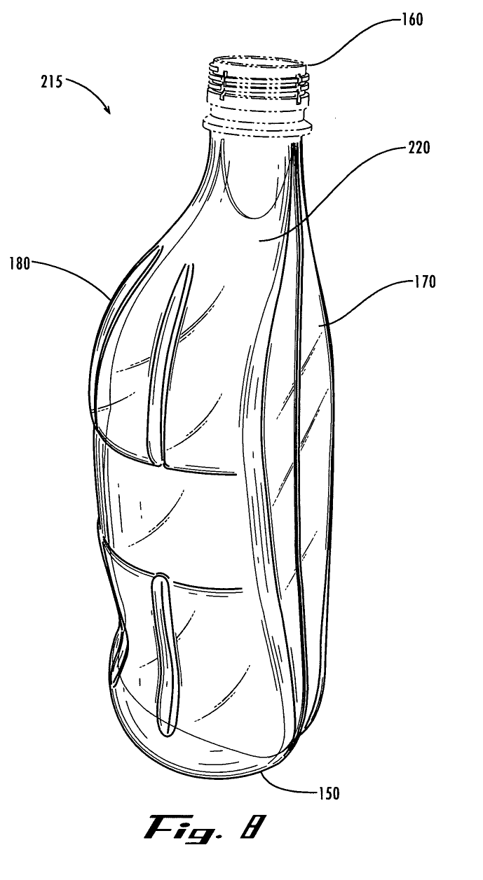

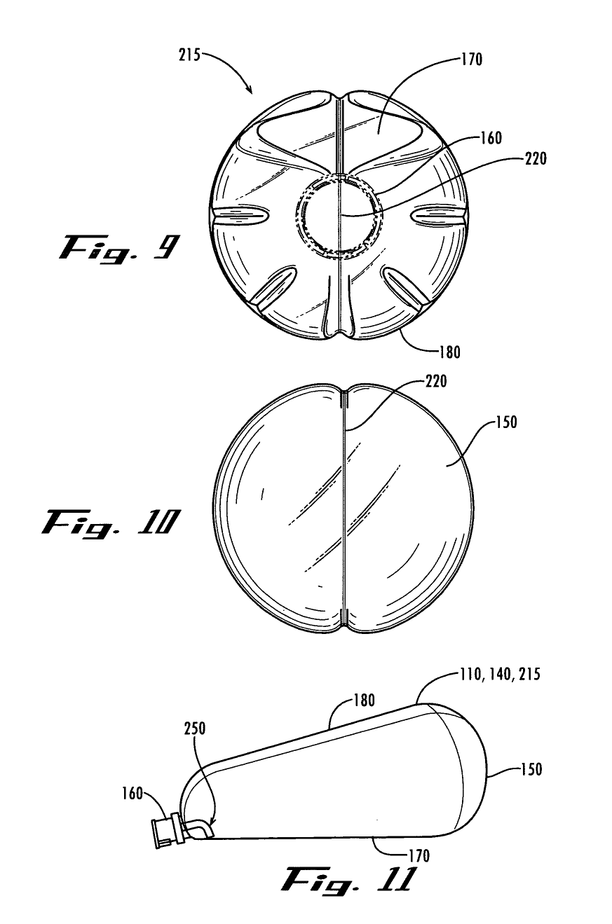

FIGS. 3-7 show an embodiment of the bottle 110. In this example, a bottle 140 is shown. The bottle 140 may have a base 150 at one end and a spout 160 on the other. The base 150 may be somewhat rounded and enlarged, i.e., the base 150 may have a generally semi-spherical shape. The enlarged base portion 150 provides the headspace for the carbon dioxide gas. The spout 160 may be of conventional design and may be offset from a center axis of the bottle 140 as drawn through the center of the base 150.

The bottle 140 may have a flat side 170 and a rounded side 180. As is shown, the use of the flat side 170 gives the bottle 140 as a whole an ornamental appearance as if part of the bottle has been removed. The flat side 170 also allows the bottle 140 to lie thereon. The flat side 170 may extend from the base 150 towards the spout 160 at an angle. In this embodiment, an angle of about six degrees (6°) may be used. Any other angle may be used as well. The use of the angle ensures that the product may flow towards the spout 160.

The rounded side 180 may take any desired shape. In this example, the rounded side 180 takes on the ornamental appearance similar to the famous contoured bottle sold by The Coca-Cola Company of Atlanta, Ga. A label panel 190 and several indentations 200 also may be used. Any desired shape for the bottle 140 as a whole may be used herein.

The shape of the bottle 140 as a whole ensures that the spout 160 is lower than the base portion 150 when the bottle 140 is positioned on its flat side 170. This design allows the closure 120, when applied, to remain “wet”, i.e., the product is maintained by gravity in contact with the closure 120. The bottle 140 may be shrink-wrapped to provide graphics and brand information.

The flat side 170 may have a number of support ribs 210 formed therein. Although the support ribs 210 may take a somewhat oblong shape as is shown, any shape may be used. The support ribs 210 themselves may or may not be used.

FIGS. 8-10 show a further embodiment of the bottle 110, in this case a bottle 215. The bottle 215 may have the base 150, the spout 160, the flat side 170, and the rounded side 180. As above, the rounded side 180 and the bottle 215 as a whole may take any desired ornamental appearance. The bottle 140 also may have an internal web 220. The web 220 may be largely perpendicular to the flat side 170 and may extend from the base 150 to near the spout 160. The web 220 assists in maintaining the shape of the flat side 170 and the lower dispensing point in light of the internal pressures created by the use of carbonated beverages.

FIGS. 11-25 show several alternative embodiments that may be used with the bottle 110, 140, 215 or any bottle intended to be used within the beverage dispenser 100 as a whole or on its own. For example, FIG. 111 shows the bottle 110, 140, 215 with an internal tube 250 that may be in communication with the closure 120. The tube 250 may be positioned such that it extends along the flat side 170. The tube 250 thus permits the closure 120 to evacuate fully the bottle 110, 140, 215 or any similar bottle when the bottle is positioned on its flat side 170.

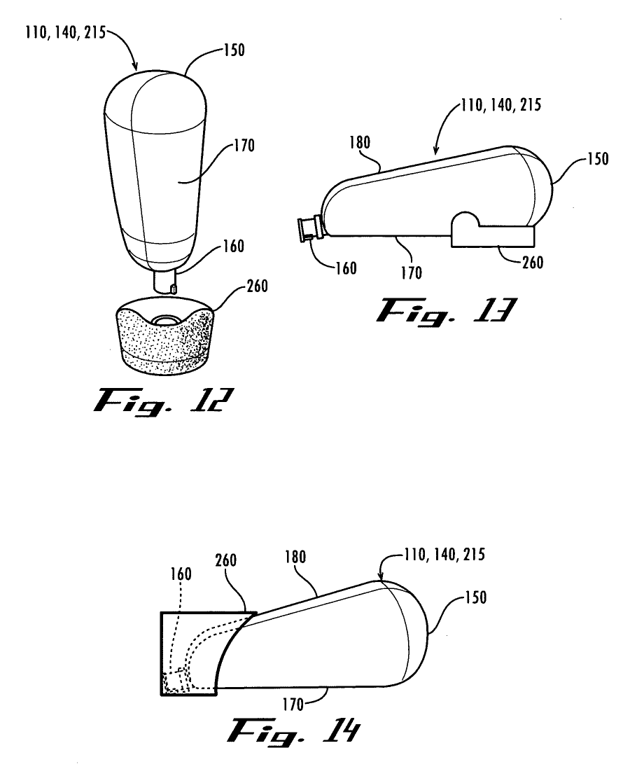

FIGS. 12-13 show the use of the bottle 110, 140, 215 or any similar bottle with a dust cap 260. The dust cap 260 may be an enlarged cup like structure that covers the spout 160 and the top part of the bottle 110, 140, 215 as a whole. The dust cap 260 enables the bottle 110, 140, 215 to be positioned upside down with the spout 160 within the dust cap 260. The dust cap 260 also may be removed from the bottle 140 and positioned underneath the bottle 110, 140, 215 along the base 150 and the flat side 170. The cap 260 thus supports the bottle 110, 140, 215 in a dispensing angle. A further embodiment of the dust cap 260 is shown in FIGS. 14-15. The dust cap 260 may take any convenient size or shape.

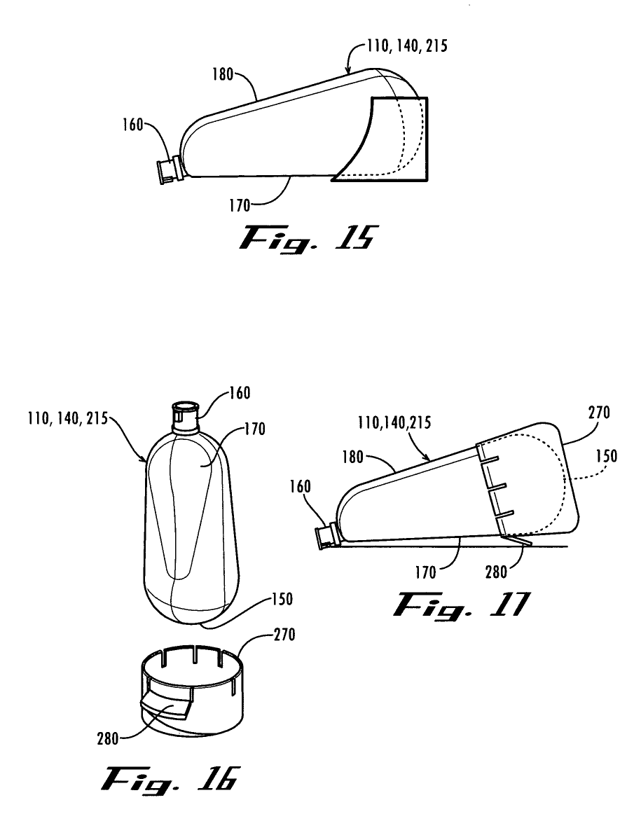

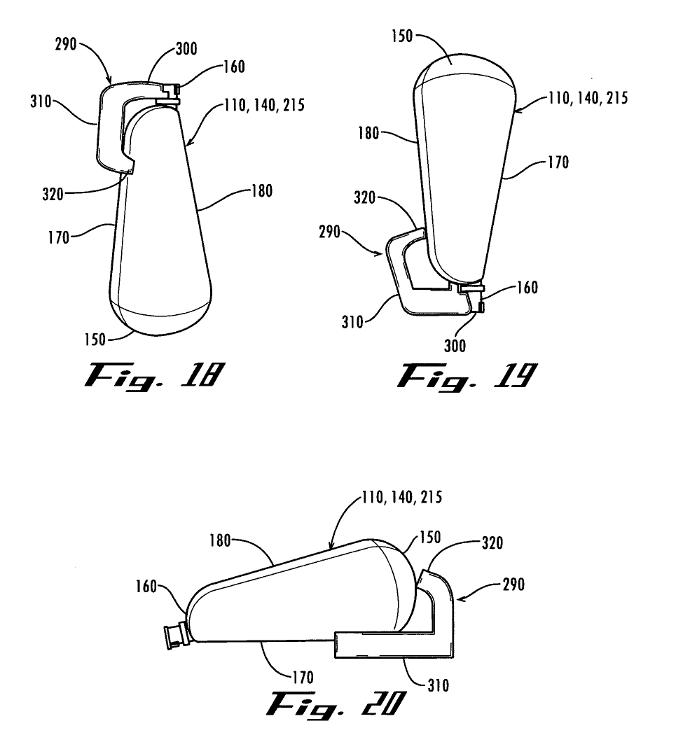

FIGS. 16-17 show the use of the bottle 110, 140, 215 or any similar bottle with a support base 270. The support base 270 also may be a cup like structure and may allow the bottle 110, 140, 215 to be positioned upright with the base 150 of the bottle 110, 140, 215 positioned therein. The support base 270 may have a tab 280 or a similar structure positioned thereon. The tab 280 may fold down such that the base 270 can support the bottle 110, 140, 215 at a dispensing angle. The support base 270 may take any convenient size or shape.

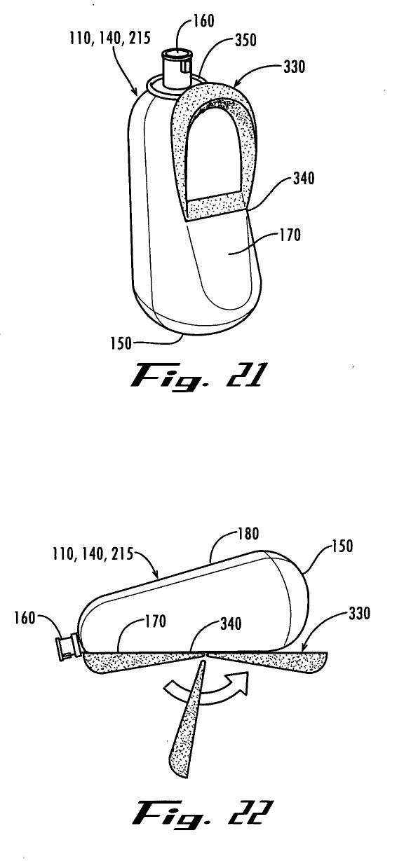

FIGS. 18-20 show the use of the bottle 110, 140, 215 or any similar bottle with a handle 290. The handle 290 may have a collar 300 that surrounds the spout 160. The handle 290 also may have a largely L-shaped arm 310 that extends from the collar 300. The arm 310 may extend to a pair of legs 320 that may be in contact with the bottle 110, 140, 215. When attached as shown in FIG. 18, the handle 290 allows the consumer to carry the bottle 110, 140, 215. When positioned as is shown in FIG. 19, the handle 290 allows the bottle 110, 140, 215 to be positioned and supported upside down. When positioned as is shown in FIG. 20, the handle 290 allows the bottle 110, 140, 215 to be positioned at a dispensing angle.

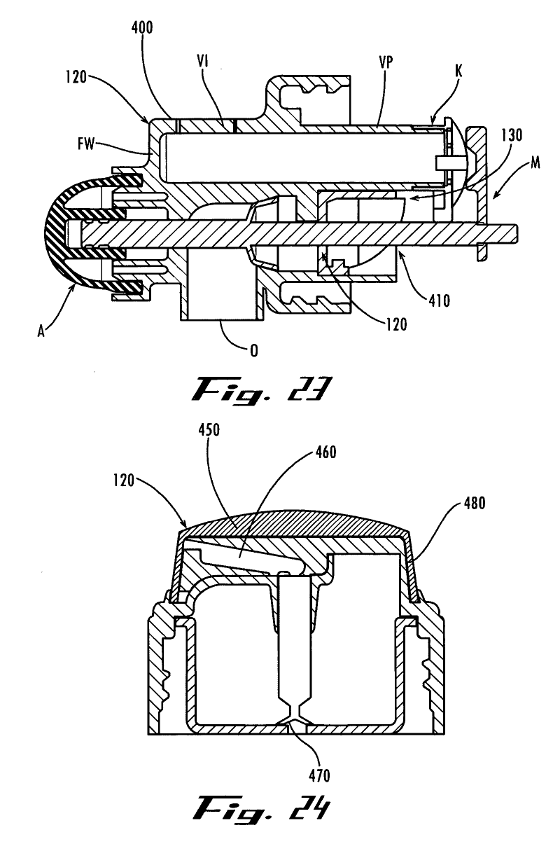

FIGS. 21-22 show a further embodiment of a handle 330. In this embodiment, the handle 330 may rotate about the flat side 170 of the bottle 110, 140, 215 or any similar bottle. The handle 330 may be attached to the bottle 110, 140, 215 via a hinge 340. The handle 330 may have a collar 350 that surrounds the spout 160. As is shown in FIG. 21, the handle 330 allows the bottle 110, 140, 215 to be carried. As shown in FIG. 22, the handle 330 can be rotated downward so as to place the bottle 110, 140, 215 at a dispensing angle.

Closure Design

FIGS. 23-24 show examples of closures 120 that may be used with the bottle 110, 140, 215 or any similar bottle. The closure 120 preferably may be applied through traditional capping equipment. The closure 120 may provide secure sealing during transportation, distribution, and storage. The closure 120 should not leak carbon dioxide gas at about 4.5 volumes when stored at about one hundred degrees (100°) Fahrenheit (about 37.8 degrees Celsius) for about fourteen (14) days. Foaming during dispensing should be minimized with carbonated products at a product temperature range of about forty degrees (40°) Fahrenheit (about 4.4 degrees Celsius) to about seventy-five degrees (75°) Fahrenheit (about 23.9 degrees Celsius). During initial dispensing, the product quality (carbonation level) should be comparable to product initially poured from a bottle. Subsequent pours should provide product quality that exceeds conventional bottle and/or pouring performance.

The material selected for the closure 120 should not create recycling issues, e.g., the materials should not be difficult to separate from PET flake during floatation separation. The density for the material should be below about one (1) Kg/Dm³. The closure 120 should fit modified versions of the current 28 millimeter or 38 millimeter finishes and preferably should be “virtually non-removable” from the bottle 110. Preferably, the closure 120 can be applied with standard-style capping equipment and capping chucks.

The closure 120 may allow for complete evacuation of the product from the bottle 110. As described above, the bottle 110 may be dispensed from a substantially horizontal position and may include an offset neck finish to facilitate gravity evacuation. The closure 120 may be designed to fit into the neck finish of the bottle 110. The overall length of the closure 120 may be minimized to allow a better fit of the complete dispenser 100 within a refrigerator. If a dust cap 260 is used, it should have sufficient visual tamper-evidence such that a tamper-evident shrink sleeve is not required.

All air venting of the bottle 110 should take place through the closure 120. The bottle 110, 140, 215 should only have one (1) opening for filling and dispensing. The vent 120 should not drip and should not allow carbon dioxide to vent at any usable carbonation level. The closure 120 should be able to be activated with one (1) hand. The closure 120 should automatically reseal after dispensing. The force required to activate the closure 120 should not exceed about five (5) pounds (about 2.3 kilograms). The flow rate should be equal to or greater than about one (1) ounce (about 29.6 milliliters) per second until the product is completely dispensed for a product temperature in a range of about forty degrees (40°) to about seventy-five degrees (75°) Fahrenheit (about 4.4 to about 23.9 degrees Celsius). The closure 120 should be able to function (open and close) about fifty (50) times without dripping.

One known closure 120 is produced by Tomlinson Industries of Cleveland, Ohio. FIG. 23 shows an example of a vented closure 400 made by Tomlinson Industries. The vented closure 400 is a form of an umbrella valve that permits product to be dispensed while maintaining carbon dioxide within the bottle 110.

For example, it can be seen that when the actuator A is manually depressed towards the front wall FW of the closure body B, the seal keeper arm M moves inward such that a passage P is formed between the seal ST and the seat VS for the passage of liquid into the outlet O. The seal keeper arm M also opens the check valve K so as to allow air to be drawn into the container space S via the vent inlet VI and the vent passage VP. The closure 400 also may have a pressure compensation 410 device that may limit the initial burst of liquid into the passage P. The pressure compensation device 410 may include a diffuser 420 and a butterfly baffle 430.

A further description of the vented closure 400 is found in U.S. patent application Ser. No. 11/087,908 filed Mar. 23, 2005 to Labinski et al. entitled “Self-Closing Vented Valve” as well as U.S. Provisional Application No. 60/555,453, filed on Mar. 23, 2004 to Labinski et al. entitled “Self-Closing Vented Valve”, both of which are incorporated herein by reference.

FIG. 24 shows a further example of the closure 120. In this case, a vent-less closure 450. The vent-less closure 450 shown herein is made by Smartseal AS of Sandnes, Norway. The vent-less closure 450 allows the product to be dispensed from the bottle 110 without the intake of additional air. As is shown, depressing a lever 460 allows a seal 470 to rise and product to pour through an opening 480. A further description of the vent-less closure 450 is found in Norwegian Patent Application Serial No. 2004-1397, filed Apr. 5, 2004, incorporated herein by reference.

Other types of closures 120 may include a “coffee urn” type closure, a “water cooler” type closure, a traditional beer keg tap, and a liquid laundry detergent closure as used on large dispensing bottles. Any type of closure 120 that permits product to be poured therethrough without permitting the loss of carbonation within the product may be used.

Various types of closures 120 have been tested and compared to known closures. The closures 120 have been compared against conventional screw-on type closures with a typical two (2) or three (3) liter bottle. The use of the closures 120 improved both the number of possible pours and the amount of pressure remaining in the product in the later pours. For example, if normal two (2) or three (3) liter bottles go “flat” in five (5) or six (6) pours or openings, the closures 120 used herein may extend the number of pours or openings to eleven (11), twelve (12), or more. The closures 120 also maintain the firmness of the bottle 110.

The Container

Although a rectangular container 130 is shown in FIG. 1, the container 130 may take any number of different shapes. The rectangular shape may be preferred because it is similar to the “Fridge-Pack” container sold by The Coca-Cola Company of Atlanta, Ga. The “Fridge-Pack” has proved to be popular with consumers because it uses the “dead” space in the refrigerator for storage. Further, the container 130 may be stacked and/or other products may be placed on the container 130 when positioned within the refrigerator. Other possible shapes include an expanded six-sided shape with a flat base; a flattened cone shape with a rounded end or a flattened base; a semi-circular shape with a flattened top shape; a squared pyramid-like shape with a semi-circular cutout near the closure 120; and any other desired size or shape. Any of the containers 130 also may have one or more transparent panels positioned therein.

The various containers 130 may be made out of cardboard, paperboard, plastic, or similar types of materials. The containers 130 may be made in a conventional manner. The containers 130 may be marketed in a vertical position but dispensed horizontally. The closure 120 may be mounted within the container 130 and a portion of the container 130 may be removed to provide access to the closure 120. Alternatively, the closure 120 may be positioned outside the container 130 as is shown. The container 130 may have graphics printed thereon. The containers 130 also may have a handle positioned thereon. The bottle 110, 140, 215 also may be used without the container 130.

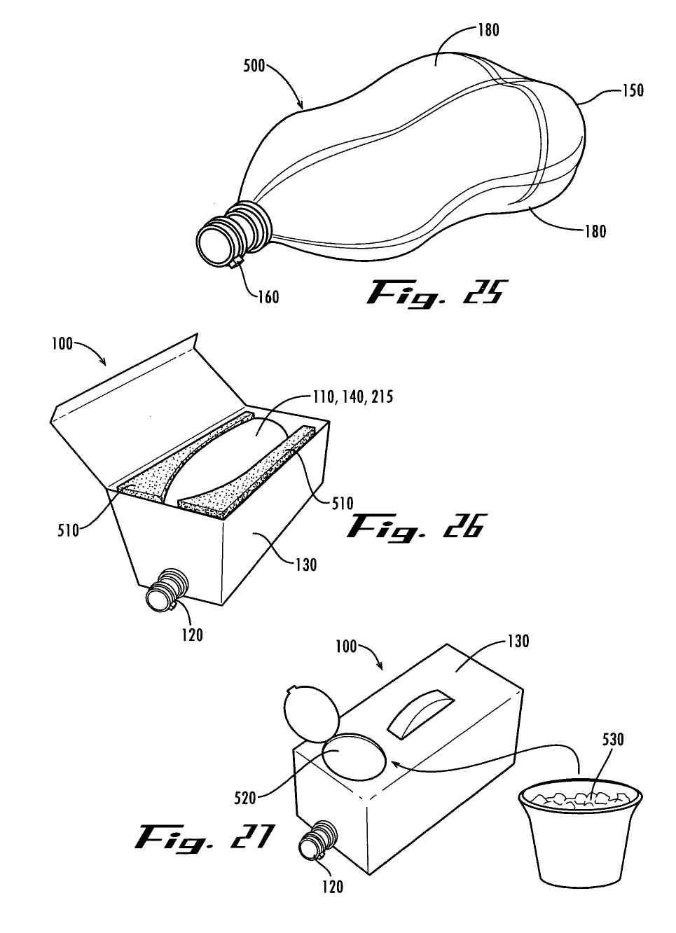

FIG. 25 shows a further embodiment of the bottle 110. In this example, a bottle 500 uses two rounded sides 180. As is shown, the overall appearance of the bottle 500 as a whole looks like that of the famous contoured bottle sold by The Coca-Cola Company of Atlanta, Ga. Again, the enlarged base 150 and the offset spout 160 are used to assist in dispensing.

FIG. 26 shows a further example of the beverage of the beverage dispenser system 100. In this example, the bottle 110, 140, 215 or any similar bottle may be positioned within the container 130. One or more inserts 510 are positioned between the bottle 110 and the container 130. The inserts 510 may be made out of foam or other types of insulating material so as to keep the product within the bottle 110 cold over a longer period of time.

FIG. 27 shows a further alternative in which the container 130 has an aperture 520 therein such that the consumer can pour ice 530 within the container 130 so as to keep the product within the bottle 110, 140, 215 or any similar bottle cold. The container 130 may be lined or made from plastic or other materials so as to make the container 130 largely waterproof.

It should be apparent to one of ordinary skill in the art that the foregoing relates only to the preferred embodiments of the present invention and that numerous changes and modifications may be made herein without departing from the spirit and scope of the invention as defined by the following claims and equivalents thereof.

1. A bottle, comprising:
an expanded rear end;
an offset spout; and
a substantially flat side positioned between the expanded rear end and the offset spout.

2. The bottle of claim 1, wherein the bottle comprises PET.

3. The bottle of claim 1, wherein the bottle comprises aluminum.

4. The bottle of claim 1, wherein the expanded end comprises a semi-sphere.

5. The bottle of claim 1, wherein the flat side comprises a plurality of support ribs therein.

6. The bottle of claim 1, wherein the flat side comprises an angle towards the offset spout.

7. The bottle of claim 1, further comprising a curved side opposite the flat side.

8. The bottle of claim 1, further comprising an internal web.

9. The bottle of claim 8, wherein the internal web is positioned substantially perpendicular to the flat side.

10. The bottle of claim 1, further comprising a closure positioned on the offset spout and wherein the closure comprises an umbrella valve.

11. The bottle of claim 1, further comprising a closure positioned on the offset spout and wherein the closure comprises a vent-less closure.

12. The bottle of claim 1, further comprising an evacuation tube positioned therein.

13. The bottle of claim 1, further comprising a dust cap for use therewith.

14. The bottle of claim 1, further comprising a handle for use therewith.

15. The bottle of claim 1, further comprising a support base for use therewith.

16. A beverage dispenser for a carbonated beverage, comprising:
a bottle;
the bottle comprising a first end and a second end and wherein the first end is rounded and wherein the second end comprises an offset spout;
the bottle further comprising a flat first side and a curved second side; and
a closure mounted onto the spout;
the closure remaining in contact with the carbonated beverage therein when dispensing.

17. The beverage dispenser of claim 16, wherein the closure comprises a vented closure.

18. The beverage dispenser of claim 16, wherein the closure comprises a vent-less closure.

19. The beverage dispenser of claim 16, wherein the bottle comprises an internal web.

20. The beverage dispenser of claim 19, wherein the internal web is positioned substantially perpendicular to the flat first side.

21. The beverage dispenser of claim 16, further comprising a container positioned about the bottle.

22. The beverage dispenser of claim 21, wherein the container comprises a rectangle.

23. The beverage dispenser of claim 21, wherein the container comprises foam inserts positioned about the bottle.

24. The beverage dispenser of claim 21, wherein the container comprises an aperture therein for the addition of ice or other types of means for cooling.

25. A dispenser for a fluid, comprising:
a fluid container;
the fluid container comprising a flat side and an internal web; and
a closure attached to the fluid container.

26. The beverage dispenser of claim 25, wherein the fluid container comprises an offset spout.

27. The beverage dispenser of claim 25, wherein the fluid container comprises a curved side opposite the flat side.

28. The beverage dispenser of claim 25, wherein the closure is a vented closure.

29. The beverage dispenser of claim 25, wherein the closure is a vent-less closure.

30. The beverage dispenser of claim 25, further comprising a rectangular box surrounding the fluid container.
